(19) United States
(12) Patent Application Publication
(10) Pub. No.: US 2026/0116467 A1
(43) Pub. Date: Apr. 30, 2026

(54) Method for Determining Contact with a Steering Handling of a Steering System

(71) Applicant: Robert Bosch GmbH, Stuttgart (DE)

(72) Inventors: Christian Guenther, Mutlangen (DE); Michael Timmons, Schwaebisch Gmuend (DE)

(21) Appl. No.: 19/365,854

(22) Filed: Oct. 22, 2025

(30) Foreign Application Priority Data
Oct. 24, 2024 (DE) 10 2024 210 268.7

(51) Int. Cl. B62D 6/00; B60W 60/00; B62D 5/00; G01D 5/243

(52) U.S. Cl. CPC B62D 6/008; B60W 60/00; B62D 5/006; G01D 5/243; B60W 2540/18

(57) ABSTRACT

A method for determining contact with a steering handle of a steering system, in particular during an automated and/or autonomous driving operation is disclosed. The steering system is configured as a steer-by-wire steering system and includes a feedback actuator coupled to the steering handle for generating a steering resistance and/or a restoring torque on the steering handle, and detection sensors associated with the feedback actuator for detecting a movement of the steering handle. The feedback actuator is subjected to an oscillating test signal in at least one operating state and a response signal of the detection sensors correlated with the test signal is determined. A phase difference between the test signal and the response signal is determined and compared with a reference value to determine contact with the steering handle.

This application claims priority under 35 U.S.C. § 119 to application no. DE 10 2024 210 268.7, filed on Oct. 24, 2024 in Germany, the disclosure of which is incorporated herein by reference in its entirety.

### BACKGROUND

The disclosure relates to a method for determining contact of a steering handle, in particular during automated and/or autonomous driving, according to description set forth below. The disclosure also relates to a computing unit for performing such a method and a vehicle comprising such a computing unit.

Also known from the prior art are vehicles comprising steer-by-wire steering systems which do not require a direct mechanical connection between a steering handle and the steered vehicle wheels and in which a steering specification is transmitted electrically. A steer-by-wire steering system of this type usually comprises an operating unit with a steering handle and a feedback actuator for generating a steering resistance and/or restoring torque, as well as at least one wheel steering angle actuator that is mechanically separated from the operating unit having a steering actuator for changing the wheel steering angle.

Moreover, vehicles today often have an automated and/or autonomous driving mode in which the vehicle can be driven at least temporarily without the driver's hands on the steering wheel or steering handle. In particular, systems with an SE L2 require the driver's constant vigilance, however, so that at least in this case the detection of the hands on the steering wheel is decisive for the operational readiness.

Particularly with regard to the steer-by-wire steering systems mentioned above, however, the determination of contact with the steering handling remains a challenge. In contrast to conventional steering systems, these systems often do not have a torque sensor for detecting a corresponding steering operation. In addition, the determination of contact based on the available operating signals due to the friction in the steering system, in particular in cases where there is no movement of the steering handling, is only possible with additional sensors installed in the steering handle.

Against this background, DE 10 2016 005 013 A1 discloses a generic method for determining a contact of a steering handle of a steering system in which an amplitude comparison is used to determine the contact.

The task of the disclosure is, in particular, to provide a method for determining contact with a steering handle of a steering system with improved properties in terms of operational safety. The object is achieved by the features of the description set forth below, while advantageous configurations and further developments of the disclosure can also be found in the description set forth below.

### SUMMARY

The disclosure relates to a method, in particular a computer-implemented method, for determining contact with a steering handle of a steering system, in particular during automated and/or autonomous driving, wherein the steering system is configured as a steer-by-wire steering system and comprises a feedback actuator coupled to the steering handle for generating a steering resistance and/or a restoring torque on the steering handle, and a detection sensor associated with the feedback actuator for detecting a movement of the steering handle, and wherein the feedback actuator is subjected to an oscillating test signal, in particular in the form of an excitation signal, in at least one operating state and a response signal of the detection sensors correlated with the test signal is determined.

It is proposed that a phase difference between the test signal and the response signal is determined and compared with a, preferably previously applied, reference magnitude to determine a contact of the steering handle. In the present case, therefore, when determining contact with the steering handling, a phase-position of the test signal and the response signal is considered. The oscillating test signal in particular results in an oscillating movement of the steering handle and is preferably configured such that the oscillating movement of the steering handle is not noticeable by a driver. If the phase difference exceeds or falls below a threshold value, it may be concluded that there is no contact with the steering handle. As a result, a response may be initiated, for example, in the form of output of an alert and/or a degradation of the steering system or vehicle. By way of this design, operational safety can in particular be improved, as a significantly more robust detection can be achieved by way of a corresponding phase comparison, in particular in comparison to an amplitude comparison. In addition, a high level of reliability can be achieved in determining the contact with the steering handle.

In the present case, the steering system is preferably configured as a steer-by-wire steering system, in which a steering specification, in particular from a driver, is transmitted purely electrically to the vehicle wheels. In this case, the steering system comprises an operating unit and at least one wheel steering angle actuator which is mechanically separate from the operating unit, said steering angle actuator being provided for changing a wheel steering angle of at least one vehicle wheel as a function of a steering specification. The steering handle is preferably part of the operating unit. In addition, the feedback actuator is preferably part of the operating unit and is mechanically coupled to the steering handle.

Furthermore, the vehicle comprises in particular a computing unit provided to perform the method for determining contact with the steering handle. The term “computing unit” is mainly understood to mean an electrical and/or electronic unit having an information input, information processing, and an information output. Advantageously, the computing unit also has at least one processor, at least one operating memory, at least one input mechanism and/or output mechanism, at least one operating program, at least one control routine, at least one regulation routine, at least one calculation routine, at least one evaluation routing and/or at least one determination routine. In particular, the computing unit is at least provided to determine a phase difference between the test signal and the response signal in order to detect contact with the steering handle, and to compare this with a reference value. In addition, the computing unit may be provided to control and/or apply an oscillating test signal to the feedback actuator in the at least one operating state and/or to determine a response signal of the detection sensors correlated with the test signal. Preferably, the computing unit is integrated into a control unit of the vehicle and/or a control unit of the steering system, in particular in the form of a steering control unit. The term “provided” is to be understood in particular as specifically programmed, designed and/or equipped. The fact that an object is provided for a specific function should be understood in particular to mean that the object fulfills and/or executes this specific function in at least one application and/or operating mode.

In addition, it is proposed that a sinusoidal signal with a specific frequency, in particular between 5 Hz and 100 Hz, and preferably between 15 Hz and 50 Hz, is used as the test signal, and the phase difference is determined at the specific frequency of the test signal. This can in particular achieve an advantageous vibration excitation and an evaluation algorithm can be simplified.

Advantageously, at least an FIR filter, i.e. a filter with a finite pulse response, is also used to determine the phase of the response signal. Preferably, the FIR filter is configured as a digital filter. In particular, an advantageously efficient and simple evaluation of the response signal can be achieved here.

Furthermore, it is proposed that the operating state is a state in which the steering handle is at a standstill for a longer period of time, in particular at least 5 s or at least 10 s, and/or in which a deflection of the steering handle remains constant for a longer period of time, in particular at least 5 s or at least 10 s. In this case, automated and/or autonomous driving operation may be, for example, longer straight-ahead driving or lane centering and/or a lane keeping functionality with fixed steering handle. Alternatively or additionally, however, the operating state can also be a state in which a start-up operation is performed, for example at a traffic light. Thus, in particularly safety-relevant operating states, contact with the steering handle by the driver can advantageously be determined or tested.

Furthermore, it is proposed that the feedback actuator includes at least one electric motor, in particular for providing a feedback torque and/or for applying a feedback torque to steering handle. In this case, rotor position sensors, in particular those associated with the electric motor, are preferably used as the detection sensors. Accordingly, the oscillating test signal may advantageously be a motor torque signal, while a rotor position signal may be used as the response signal. In particular, a particularly efficient determination of contact with the steering handle can be achieved, wherein existing operating signals of the steering system can be used.

According to another embodiment, it is proposed that an amplitude response signal is further considered when determining contact with the steering handle. In addition, the amplitude of the response signal can thus also be determined and evaluated for determining contact with the steering handling and/or used to plausibly verify the determined contact. For this purpose, the amplitude can be compared with a further reference value, preferably applied in advance, in particular at the specific frequency of the test signal. Furthermore, in this case, an FIR filter, i.e. a filter with an infinite pulse response, may again be used to determine the amplitude of the response signal. Preferably, the FIR filter is configured as a digital filter. In the present case, the phase and amplitude of the response signal may be advantageously determined using the same FIR filter. Moreover, a warning may be generated if the phase difference is below a threshold value and the amplitude exceeds another threshold value. This can in particular further increase operational reliability.

The method for determining contact with the steering handle and the vehicle are not intended to be limited to the application and embodiment described above. In particular, the method for determining contact with the steering handle and the vehicle in order to achieve the functioning described herein may comprise a number of individual elements, components, and units that differ from the number specified herein.

### BRIEF DESCRIPTION OF THE DRAWINGS

Further advantages follow from the description of the drawings below. The drawings show an exemplary embodiment of the disclosure.

The figures show:

FIGS. 1a-b a vehicle with a steering system designed as a steer-by-wire steering system in a simplified representation,

FIG. 2 a diagram of various signals for determining contact with a steering handle of the steering system, and

FIG. 3 an exemplary flow chart comprising the main method steps of a method for determining contact with the steering handle.

### DETAILED DESCRIPTION

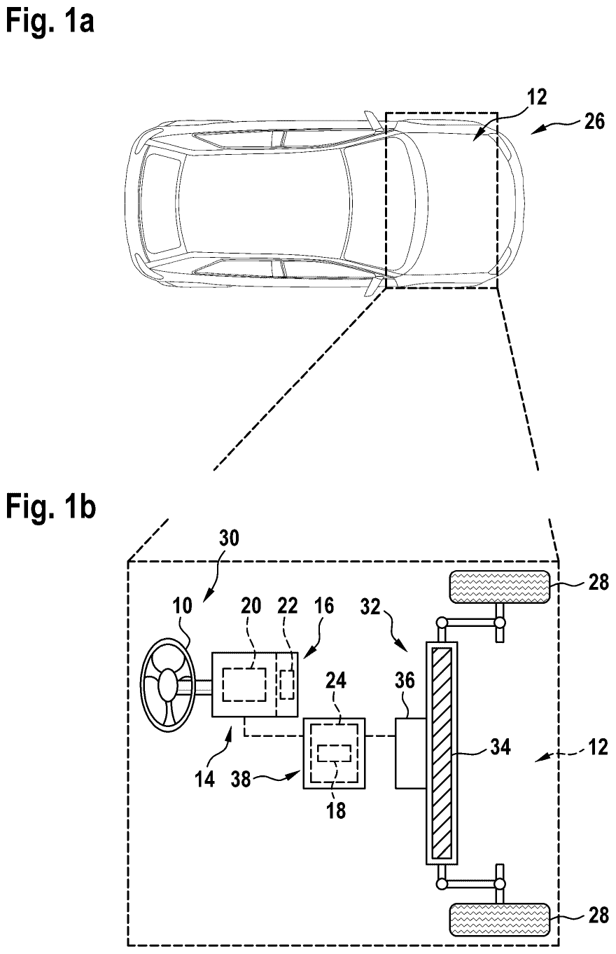

FIGS. 1a and 1b show a simplified illustration of a vehicle 26 which is, e.g., designed as a passenger vehicle, or more precisely as a passenger car, comprising a plurality of vehicle wheels 28 and a steering system 12. The vehicle 26 has an automated and/or autonomous driving mode, for example, in the form of lane centering and/or lane keeping functionality. The steering system 12 is operatively connected to the vehicle wheels 28 and is provided to influence a direction of travel of the vehicle 26. Furthermore, the steering system 12 is designed as a steer-by-wire steering system in the present case, in which a steering specification is transmitted electrically to the vehicle wheels 28 in at least one operating state.

The steering system 12 comprises an operating unit 30, in particular actuatable by a driver and/or an occupant. The operating unit 30 comprises a steering handle 10, for example, in the form of a steering wheel, and a feedback actuator 14 which is mechanically coupled to the steering handle 10. The feedback actuator 14 is provided to provide an active feedback torque and thereby to generate a steering resistance and/or a restoring torque on the steering handle 10. To this end, the feedback actuator 14 includes an electric motor 20. A steering handle could alternatively also be designed as a joystick, a steering lever, and/or as a steering ball or the like. A feedback actuator could in principle further comprise a plurality of electric motors.

The operator unit 30 further comprises detection sensors 16. The detection sensors 16 is arranged in and associated with an area of feedback actuator 14. The detection sensors 16 are provided at least to detect a movement of the steering handle 10 and to provide it as a detection signal. In the present case, the detection sensors 16 comprise at least one rotor position sensor 22. Accordingly, the detection sensors 16 comprise at least one rotor position sensor (not explicitly shown) cooperating with the electric motor 20 of the feedback actuator 14. Alternatively or additionally, however, detection sensors for detecting a movement of a steering handle could also comprise at least one current sensor. In addition, detection sensors could also comprise a plurality of rotor position and/or current sensors.

The steering system 12 further comprises a wheel steering angle control element 32. The wheel steering angle control element 32 is mechanically separate from the operating unit 30. The wheel steering angle control element 32 is purely electrically connected to the operating unit 30. Furthermore, the wheel steering angle control element 32 is designed as a central actuator in the present case. The wheel steering angle control element 32 is operatively connected to at least two of the vehicle wheels 28, in particular two front wheels, and is intended to convert the steering specification into a steering movement of the vehicle wheels 28. To this end, the wheel steering angle control element 32 includes a steering control element 34, particularly in the form of a gear rack, and a steering actuator 36, particularly in the form of an electric motor, that cooperates with the steering control element 34. A steering system could in principle also comprise a plurality of wheel steering angle control elements, in particular designed as single wheel actuators. Furthermore, a steering actuator could be configured as, for example, a linear drive and/or comprise a plurality of electric motors.

The vehicle 26 further comprises a control device 38. In the present case, the control device 38 is designed as a steering control device and is therefore part of the steering system 12. The control device 38 has an electrical connection to the operator unit 30, in particular the feedback actuator 14 and the detection sensors 16. The control device 38 further comprises an electrical connection to the wheel steering angle control element 32, in particular the steering actuator 36. The control device 38 is provided at least for controlling an operation of the steering system 12. A control device could in principle also be different from a steering control device and designed, e.g., as a single, central vehicle control device. It is also conceivable to provide separate control devices for one wheel steering angle control element as well as one operating unit and communicatively interconnect them.

The control unit 38 comprises a computing unit 24. The computing unit 24 comprises at least one processor (not depicted), e.g., in the form of a microprocessor, and at least one operating memory (not depicted). The computing unit 24 also comprises at least one operating program stored in the operating memory and has at least one control routine, at least one calculation routine and at least one determination routine. In the present case, the computing unit 24 also comprises at least one FIR filter 18. The FIR filter 18 is configured as a digital filter. In principle, however, an FIR filter could also be configured as an analog filter.

To improve the determination of contact with the steering handle 10, in particular during automated and/or autonomous driving operation, and to increase operational safety, an exemplary method for determining contact with the steering handle 10 is described below. In the present case, the computing unit 24 is provided to perform the method and comprises for this purpose a computer program having corresponding program code means. In general, however, another computing unit, for example a central vehicle control device, could alternatively be provided for performing the method.

In the present case, the feedback actuator 14 is subjected to an oscillating test signal, in particular in the form of a motor torque signal, in at least one operating state, in particular during automated and/or autonomous driving, more precisely in a state in which the steering handle 10 is at a standstill for a longer period of time and/or a deflection of the steering handle 10 remains constant for a longer period of time, and a response signal of the detection sensors 16 correlated with the test signal, in the present case in particular in the form of a rotor torque signal, is determined. To determine contact with the steering handle 10, a phase difference is then determined between the test signal and the response signal, in particular using the FIR filter 18, and compared with a reference value. If the phase difference exceeds or falls below a threshold value, a response may be initiated, for example, in the form of an alert output and/or a degradation of the steering system 12 and/or the vehicle 26. Alternatively or additionally, however, the operating state can also be a state in which a start-up operation is performed, for example at a traffic light.

In the present case, the test signal is configured to result in an oscillating movement of the steering handle 10, but the oscillating movement of the steering handle 10 is not discernible by a driver. In the present case, the test signal is a sinusoidal signal with a specific frequency of between 5 Hz and 100 Hz, where the phase difference is determined at the specific frequency of the test signal. For example, a sine generator may be used to generate the test signal. The specific frequency in the present case is 19 Hz, example.

In accordance with a preferred further development, an amplitude of the response signal may further be considered when determining contact with the steering handle 10. The amplitude can be determined, for example, by way of the FIR filter 18 and compared with a further reference value, in particular at the specific frequency of the test signal, whereby an accuracy of the method can be further improved and/or a plausibility check of the previously determined contact can be achieved. In the present case, the phase and amplitude of the response signal may thus be determined using the same FIR filter 18. However, it is also generally conceivable to use different FIR filters to determine a phase and an amplitude of a response signal. Further, for example, a warning may only be generated if the phase difference falls below a threshold value and the amplitude simultaneously exceeds another threshold value.

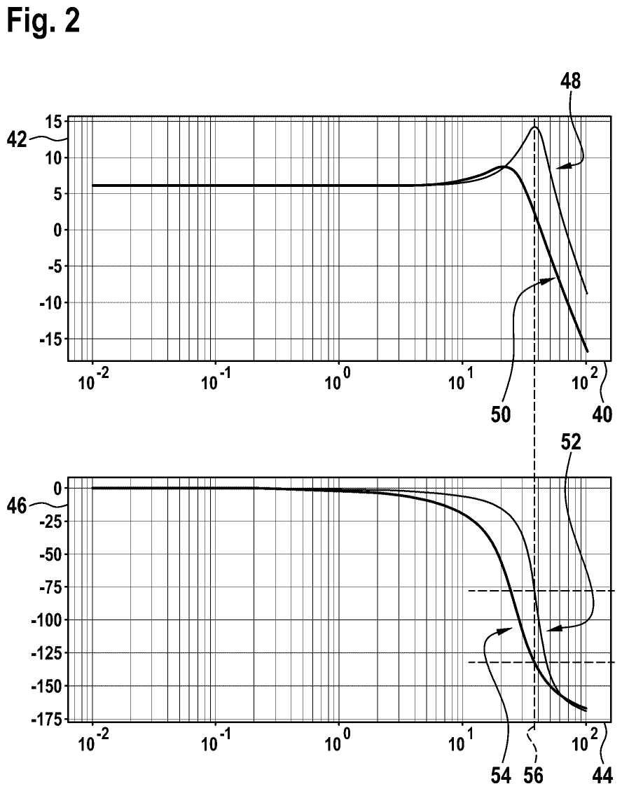

FIG. 2 shows an exemplary diagram of various signals for determining contact with the steering handle 10. The present diagram is merely used to illustrate the disclosure and shows the possible amplitude and the phase position of the response signal in an exemplary bode diagram, namely in the case that the driver has hands on the steering handle 10 and in the case that the driver does not contact the steering handle 10.

A frequency in [Hz] is plotted on a first abscess axis 40, while the amplitude is plotted in [dB] on a first ordinate axis 42. The frequency is also plotted in [Hz] on a second abscess axis 44, while the phase is plotted in [°] on a second ordinate axis 46. A first curve 48 shows the amplitude in the case where the driver does not contact the steering handle 10, while a second curve 50 shows the amplitude in the case where driver has hands on the steering handle 10. The same applies to the third curve 52 and the fourth curve 54 with respect to the phase, wherein the third curve 52 represents the case where the driver does not contact the steering handle 10, while the fourth curve 54 represents the case where the driver has hands on the steering handle 10. Also, by way of a vertical line 56, the specific frequency of the test signal is characterized, which in the present case is at 19 Hz. For example, the second curve 50 may be used to determine the further reference value and the fourth curve 54 to determine the reference value.

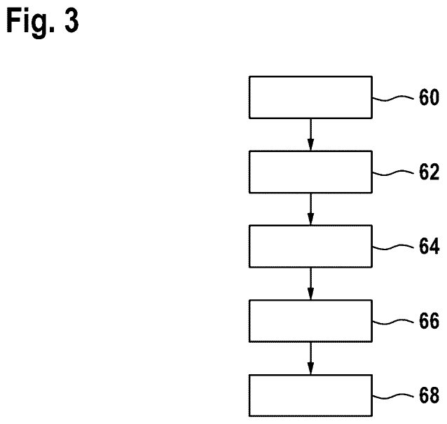

Finally FIG. 3 shows an exemplary flow chart with the main method steps of the method for determining contact with the steering handle 10.

In a method step 60, which is carried out in particular in a driving operation of the vehicle 26, it is first checked whether the steering handle 10 is at a standstill for a longer period of time, in particular at least 5 s, and/or whether a deflection of the steering handle 10 remains constant for a longer period of time, in particular at least 5 s. A corresponding operating state may arise, for example, in an automated and/or autonomous driving operation, for example in the form of lane centering and/or lane keeping functionality with fixed steering handle 10, and/or in a start-up operation, for example at a traffic light.

If this is the case, in a subsequent method step 62, the feedback actuator 14, more specifically the electric motor 20, is subjected to an oscillating test signal, in particular in the form of a motor torque signal. For example, a sine generator may be used to generate the test signal. In this context, the test signal can also be superimposed on a driving signal of the feedback actuator 14 to generate a feedback torque or a, in particular field-oriented, control algorithm.

Subsequently, in a method step 64, a response signal of sensing sensor technology 16 correlated to the test signal is determined. Preferably, the response signal may be a rotor position signal sensed by rotor layer sensors 22 and correlated to a movement of the electric motor 22.

In a method step 66, a phase difference between the test signal and the response signal is then determined to determine contact with the steering handle 10, wherein the phase difference is determined in particular at the specific frequency of the test signal. In addition, the phase difference is compared with a reference value. If the phase difference exceeds or falls below a threshold value, it may be concluded that there is no contact with the steering handle 10.

As a result, a response may be initiated in method step 68. For example, in the present case, an alert can be generated and issued to take over the steering handle 10. If further contact with the steering handle 10 cannot be subsequently determined, a degradation of the steering system 12 or the vehicle 26 can also take place.

The flow chart in FIG. 3 is only intended to describe an exemplary method for determining a contact with the steering handle 10. In particular, individual method steps may also vary, or additional method steps may be added. For example, it is contemplated to further consider an amplitude of the response signal when determining contact with the steering handle 10. In addition, an FIR filter may be used to determine the phase of the response signal and/or to determine the amplitude of the response signal.

What is claimed is:

1. A method for determining contact with a steering handle of a steering system during an automated and/or autonomous driving operation, wherein the steering system is configured as a steer-by-wire steering system and comprises (i) a feedback actuator coupled to the steering handle and configured to generate a steering resistance and/or a restoring torque on the steering handle, and (ii) a detection sensor associated with the feedback actuator and configured to detect a movement of the steering handle, the method comprising:
subjecting the feedback actuator to an oscillating test signal in at least one operating state, and determining a response signal of the detection sensor system correlated with the test signal; and
determining a phase difference between the test signal and the response signal, and comparing the phase difference with a reference value in order to determine contact with the steering handle.

2. The method according to claim 1, wherein a sinusoidal signal with a specific frequency is used as the test signal and the phase difference is determined at the specific frequency of the test signal.

3. The method according to claim 1, wherein at least one FIR filter is used to determine the phase of the response signal.

4. The method according to claim 1, wherein the operating state is a state in which the steering handle is at a standstill for a longer period of time, and/or a deflection of the steering handle remains constant for a longer period of time, and/or in which a start-up process takes place.

5. The method according to claim 1, wherein the feedback actuator comprises at least one electric motor and rotor position sensors are used as the detection sensors.

6. The method according to claim 1, wherein:
when determining contact with the steering handle, an amplitude of the response signal is further considered.

7. The method according to claim 6, wherein an FIR filter is used to determine the amplitude of the response signal.

8. The method according to claim 6, wherein the amplitude is compared with a further reference value, and a warning is generated if the phase difference falls below a threshold value and the amplitude exceeds a further threshold value.

9. A computing unit for performing a method according to claim 1.

10. A motor vehicle having a steering system configured as a steer-by-wire steering system, the steering system comprising:
a steering handle;
a feedback actuator coupled to the steering handle and configured to generate a steering resistance and/or a restoring torque on the steering handle; and
detection sensors associated with the feedback actuator and configured to detect a movement of the steering handle; and
the computing unit according to claim 9.

11. The method according to claim 2, wherein the specific frequency is between 5 Hz and 100 Hz.

12. The method according to claim 1, wherein the operating state is a state in which the steering handle is at a standstill for at least 5 seconds, and/or a deflection of the steering handle remains constant for at least 5 seconds, and/or in which a start-up process takes place.
